(19) United States
(12) Patent Application Publication
(10) Pub. No.: US 2009/0243787 A1
(43) Pub. Date: Oct. 1, 2009

(54) Electrical fuse devices and methods of operating the same

(75) Inventors: Soo-Jung Hwang, Seoul (KR); Ha-young You, Seoul (KR); Deok-kee Kim, Seoul (KR); Jung-hun Sung, Yongin-si (KR); Young-chang Joo, Seoul (KR); Sung-yup Jung, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/382,877

(22) Filed: Mar. 26, 2009

(30) Foreign Application Priority Data
Mar. 26, 2008 (KR) 10-2008-0028068

(51) Int. Cl. H01H 85/04

(52) U.S. Cl. 337/293

(57) ABSTRACT

Provided are an electrical fuse device and a method of operating the same. The electrical fuse device may include a fuse link having a multi layer structure with at least two metal layers. The number of metal layers that are blown, from among the at least two metal layers, may vary according to either the duration of application of voltage or the strength of voltage applied.

### PRIORITY STATEMENT

This application claims priority under 35 USC §119 to Korean Patent Application No. 10-2008-0028068, filed on Mar. 26, 2008, in the Korean Intellectual Property Office (KIPO), the entire contents of which are incorporated herein by reference.

### BACKGROUND

1. Field

Example embodiments relate to an electrical device and methods of operating the same, and more particularly, to an electrical fuse device and methods of operating the same.

2. Description of the Related Art

A fuse device is used in semiconductor memory devices or logic devices for various purposes, e.g., in the replacement of a defective cell, storing a chip identification (ID), or circuit customization. For example, among a larger number of cells in a memory device, cells determined as defective may be replaced with redundancy cells by a fuse device. Accordingly, a decrease in a manufacturing yield due to defective cells may be resolved. There are two types of fuse devices: a laser-blown type and an electrically-blown type. A laser-blown type fuse device uses a laser beam to blow a fuse line. However, when irradiating the laser beam to a particular fuse line, fuse lines adjacent to the particular fuse link and/or other devices may be damaged.

On the other hand, an electrically-blown type fuse device may apply a programming current to a fuse link so that the fuse link may be blown due to an electromigration (EM) effect and a Joule heating effect. The method of electrically blowing a fuse may be used after packaging of a semiconductor chip is completed, and a fuse device employing the method may be an electrical fuse device.

A conventional electrically-blown type fuse device includes a silicon-based fuse link. However, for higher integration and lower power consumption of a semiconductor device, improving the configuration of the conventional electrically-blown type fuse device may be necessary. Furthermore, conventional fuse devices are single bit devices, that is, devices to each of which a single bit of data, for example, “0” or “1”, is recorded. Thus, there are limits in increasing the integration degree and the capacity of the conventional fuse devices.

### SUMMARY

Example embodiments provide an electrical fuse device including a fuse link. Example embodiments also provide a method of operating the electrical fuse device.

According to example embodiments, an electrical fuse device may include a cathode and an anode separated from each other; and a fuse link connecting the cathode and the anode, wherein the fuse link may include at least two stacked metal layers, and the number of metal layers that are blown, from among the at least two metal layers vary according to one of the strength and the duration of application of a voltage to the fuse link.

The fuse link may include a first lower metal layer; and a first upper metal layer on the first lower metal layer. The first lower metal layer and the first upper metal layer may have different electrical resistances from each other. The first lower metal layer and the first upper metal layer may have different melting points from each other.

One of the first lower metal layer and the first upper metal layer may include one of W, Al, Cu, Ag, Au, and Pt. The other one of the first lower metal layer and the first upper metal layer may include one of Ti, TiN, Ta, TaN, TiSi, TaSi, TiSiN, TaSiN, TiAl₃, and TiON. The fuse link may further include a second lower metal layer below the first lower metal layer. At least two of the first lower metal layer, the second lower metal layer, and the first upper metal layer may have different electrical resistances from each other.

At least two of the first lower metal layer, the second lower metal layer, and the first upper metal layer may have different melting points from each other. One of the first lower metal layer, the second lower metal layer, and the first upper metal layer may include one of W, Al, Cu, Ag, Au, and Pt. Another one of the first lower metal layer, the second lower metal layer, and the first upper metal layer may include one of Ti, TiN, Ta, TaN, TiSi, TaSi, TiSiN, TaSiN, TiAl₃, and TiON.

The other one of the first lower metal layer, the second lower metal layer, and the first upper metal layer may include one of Ti, TiN, Ta, TaN, TiSi, TaSi, TiSiN, TaSiN, TiAl₃, and TiON. The fuse link may further include at least one metal layer on the first upper metal layer. The at least one metal layer may be an ARC (anti-reflective coating) layer. The at least one metal layer may have either a single layer structure or a multi layer structure, both of which include at least one of Ti, TiN, Ta, TaN, TiSi, TaSi, TiSiN, TaSiN, TiAl₃, and TiON.

According to example embodiments, a method of operating an electrical fuse device, in which a fuse link is between a cathode and an anode, and the fuse link includes at least two stacked metal layers, the method including blowing at least one of the at least two metal layers.

When the strength of a voltage applied between the cathode and the anode is constant, the number of metal layers that are blown, from among the at least two metal layers, may be determined by the duration of application of the voltage.

The number of metal layers that are blown, from among the at least two metal layers, may be determined by the strength of a voltage applied between the cathode and the anode. At least two of the at least two metal layers may have different electrical resistances from each other. At least two of the at least two metal layers may have different melting points from each other.

### BRIEF DESCRIPTION OF THE DRAWINGS

Example embodiments will be more clearly understood from the following detailed description taken in conjunction with the accompanying drawings. FIGS. 1-14 represent non-limiting, example embodiments as described herein.

FIG. 1 is a plan view of an electrical fuse device according to example embodiments in a first state;

FIG. 2 is a sectional view obtained along line I-I′ of FIG. 1;

FIGS. 3 and 4 are sectional views showing a second state and a third state of the electrical fuse device of FIG. 1;

FIGS. 5(A)-(C) are sectional views showing a method of programming the fuse device of FIG. 1, according to example embodiments;

FIG. 6 is a graph showing changes of electric current in the fuse device of FIG. 1 with respect to durations of applying a programming voltage, according to example embodiments;

FIG. 7 is a graph showing changes of electrical resistance in the fuse device of FIG. 1 with respect to the duration of applying the programming voltage;

FIGS. 8 through 11 are sectional views showing first through fourth states of an electrical fuse device according to example embodiments;

FIG. 12 is a graph showing changes of electric current in the fuse device of FIG. 8 with respect to the duration of applying programming voltages with different strengths;

FIG. 13 is a graph showing changes of electrical resistance in the fuse device of FIG. 8 with respect to strength of programming voltages applied; and

FIG. 14 is a sectional view of an electrical fuse device according to example embodiments.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Various example embodiments will now be described more fully with reference to the accompanying drawings in which some example embodiments are shown. Detailed illustrative example embodiments are disclosed herein. However, specific structural and functional details disclosed herein are merely representative for purposes of describing example embodiments. Example embodiments, however, may be embodied in many alternative forms and should not be construed as limited to only example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items.

It will be understood that when an element or layer is referred to as being “formed on,” another element or layer, it can be directly or indirectly formed on the other element or layer. That is, for example, intervening element or layers may be present. In contrast, when an element or layer is referred to as being “directly formed on,” to another element, there are no intervening elements or layers present. Other words used to describe the relationship between elements or layers should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not precluded the presence or addition of one or more other features, integers, steps, operations, elements, components, and/or groups thereof. In the drawings, the thicknesses of layers and regions are exaggerated for clarity. Like reference numerals in the drawings denote like elements.

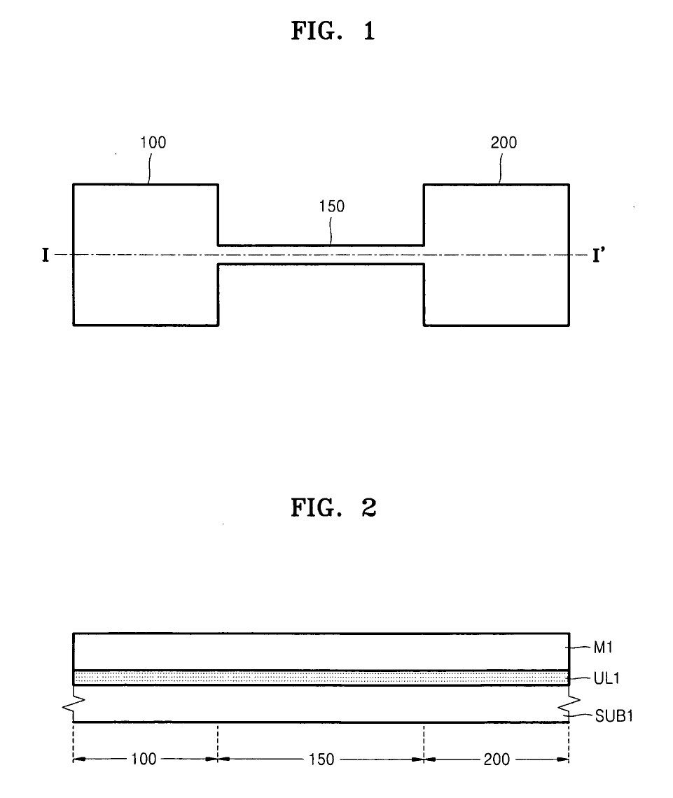

FIG. 1 is a plan view of an electrical fuse device according to example embodiments, and FIG. 2 is a sectional view obtained along line I-I′ of FIG. 1. Referring to FIG. 1, the electrical fuse device may include a cathode 100 and an anode 200 that are located apart from each other, and a fuse link 150 between the cathode 100 and the anode 200 so as to link the cathode 100 and the anode 200. The shapes of the cathode 100 and the anode 200 may be rectangular. However, example embodiments are not limited thereto, the shapes of the cathode 100 and the anode 200 may vary, and their sizes and size ratio may vary as well.

The fuse link 150 may have a width significantly smaller than those of the cathode 100 and the anode 200. For example, the fuse link 150 may have a width between about several tens of nm to several hundreds of nm and a length between about several tens of nm and several μm. When a current exceeding a critical point flows through the fuse link 150, a particular region of the fuse link 150 may be blown due to electromigration (EM) effect and/or thermomigration (TM) effect and/or Joule heating effect. As the width of the fuse link 150 decreases and the length of the fuse link 150 increases, the fuse link 150 may be blown more easily.

Referring to FIG. 2, the fuse link 150 may include a multi metal layer structure. More particularly, the fuse link 150 may include a first lower metal layer UL1 and a first upper metal layer M1 stacked sequentially on a semiconductor substrate SUB1. The resistance of the first upper metal layer M1 may be lower than the resistance of the first lower metal layer UL1. Furthermore, the melting point of the first upper metal layer M1 may be lower than that of the first lower metal layer UL1. For example, the first upper metal layer M1 may include one of W, Al, Cu, Ag, Au, and Pt, whereas the first lower metal layer UL1 may include one of Ti, TiN, Ta, TaN, TiSi, TaSi, TiSiN, TaSiN, TiAl₃, and TiON.

The specific resistances of W, Al, Cu, Ag, Au, and Pt are about 5.65×10⁻⁶ Ω·cm, 2.65×10⁻⁶ Ω·cm, 1.7×10⁻⁶ Ω·cm, 1.6×10⁻⁶ Ω·cm, 2.2×10⁻⁶ Ω·cm, and 10.6×10⁻⁶ Ω·cm, respectively. The specific resistances of Ti, TiN, and Ta are about 42×10⁻⁶ Ω·cm, 100×10⁻⁶˜130×10⁻⁶ Ω·cm, and 13×10⁻⁶ Ω·cm, respectively. The melting points of W, Al, Cu, Ag, Au, and Pt are about 3683° C., 660.32° C., 1084.62° C., 961.78° C., 1064.18° C., and 1768.3° C., respectively. The melting points of Ta, TiN, Ta, and TaN are about 1941° C., 3223° C., 3017° C., and 3380° C., respectively. However, example embodiments are not limited thereto, and materials for forming the first upper metal layer M1 and the first lower metal layer UL1 may vary. The cathode 100 and the anode 200 may have the same stack structure as the fuse link 150. An electrical fuse device including the multi metal layer structure may be more easily formed together with a metal gate or metal wiring of a cell region of a semiconductor substrate in conventional methods of fabricating a semiconductor device.

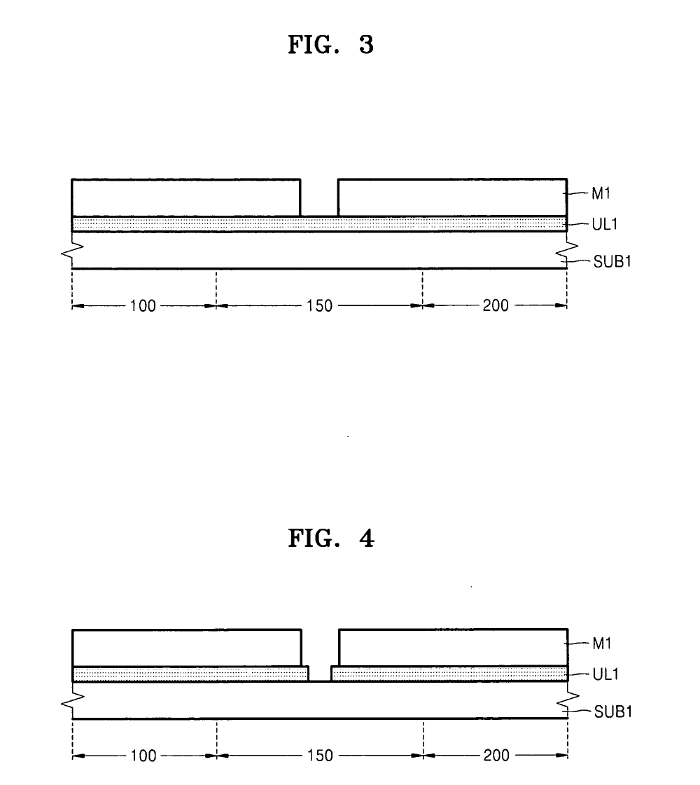

Although not shown in FIGS. 1 and 2, the cathode 100 or the anode 200 may be connected to a sensing circuit and a programming transistor. Because the sensing circuit and the programming transistor are well known to one skilled in the art, a detailed description thereof will be omitted. The fuse device of FIG. 2 may correspond to a first state in which the fuse device has a first electrical resistance R1, and may be shifted to states shown in FIGS. 3 and 4 due to programming operations.

Referring to FIG. 3, in the fuse link 150, a predetermined or given region of the first upper metal layer M1 may be blown whereas the first lower metal layer UL1 is not blown. Thus, the fuse device of FIG. 3 may correspond to a second state in which the fuse device has a second electrical resistance R2. Referring to FIG. 4, in the fuse link 150, predetermined or given regions of the first upper metal layer M1 and the first lower metal layer UL1 may be blown. Thus, the fuse device of FIG. 4 may correspond to a third state in which the fuse device has a third electrical resistance R3. The first through third electrical resistances R1 through R3 may be electrical resistances between the cathode 100 and the anode 200, and the relationship among the first through third electrical resistances R1 through R3 may be R1<R2<R3. Thus, the first through third states may correspond to data “00,” “01,” and “10,” respectively.

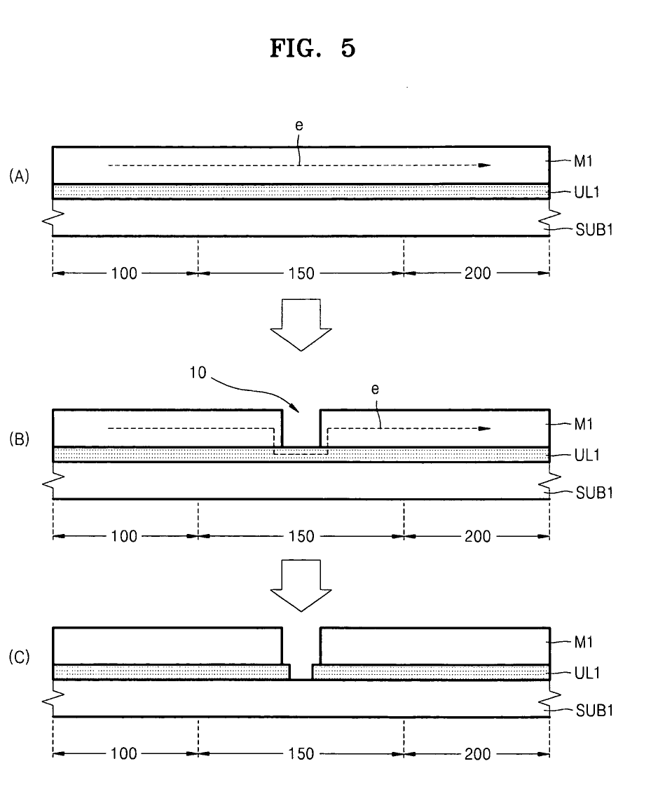

FIGS. 5(A)-(C) are sectional views showing a method of programming a fuse device according to example embodiments. Referring to FIG. 5(A), when electric current flows from the anode 200 to the cathode 100 due to application of a programming voltage exceeding the critical voltage between the cathode 100 and the anode 200, electrons (e) may move from the cathode 100 to the anode 200. In example embodiments, because the electrical resistance of the first upper metal layer M1 is lower than that of the first lower metal layer UL1, the electrons (e) may move mostly through the first upper metal layer M1.

Therefore, the electrons (e) may cause the EM and/or the TM and/or a Joule heating effects in the first upper metal layer M1, and thus, a particular region of the first upper metal layer M1 of the fuse link 150 may be blown, as shown in FIG. 5 (B). More particularly, due to the Joule heating effect, phenomenon, e.g., melting/agglomeration, TM, and vaporization, may occur independently or in coordination. The phenomenon may occur together with the EM, and thus, the first upper metal layer M1 may be blown. In FIG. 5(B), the reference number 10 refers to a region of the first upper metal layer M1 to be blown, that is, a blown region 10. When a predetermined or given region of the first upper metal layer M1 is blown, electrons (e) may flow through a portion of the first lower metal layer UL1 below the blown region 10 of the first upper metal layer M1. Due to the flow of electrons (e), the width of the blown region 10 may increase. In other words, the first upper metal layer M1 may be blown due to the electrons (e) flowing through the first lower metal layer UL1.

If the programming voltage is continuously applied, the electrons (e) may also cause the EM and/or the TM and/or the Joule heating effects in the first lower metal layer UL1. Thus, as shown in FIG. 5(C), a predetermined or given region of the first lower metal layer UL1 of the fuse link 150 may be blown. The portion of the first lower metal layer UL1 below the blown region 10 of the first upper metal layer M1 may be blown.

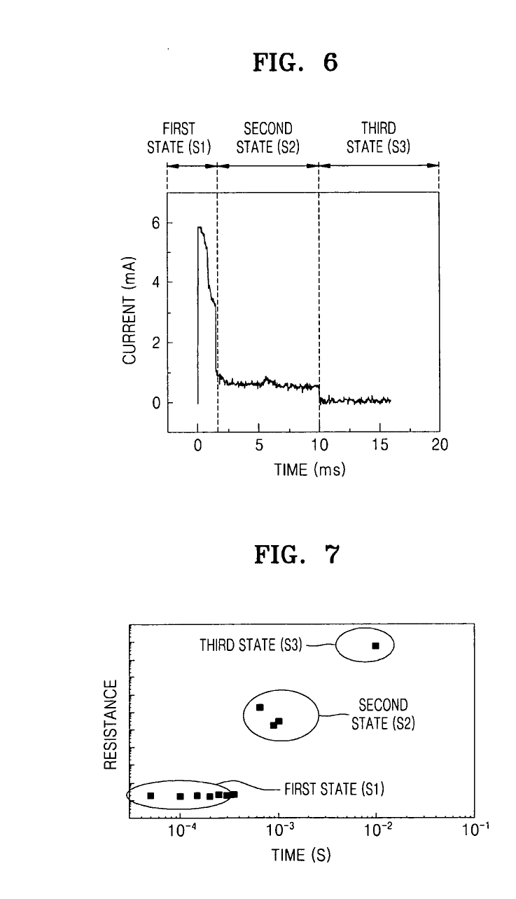

FIG. 6 is a graph showing changes of electric current in a fuse device with respect to durations of applying a programming voltage between the cathode 100 and the anode 200, according to example embodiments. The results shown in FIG. 4 are regarding a fuse device having the structure of FIG. 2 yet using a TiN layer and a W layer as the first lower metal layer UL1 and the first upper metal layer M1, respectively.

Referring to FIG. 6, electric current in the fuse device decreases in stepped decrements as the duration of applying the programming voltage increases. In other words, the state of the fuse device is shifted from a first state S1 to a second state S2, and then is shifted to a third state S3. The first through third states S1 through S3 correspond to states shown in FIGS. 2 through 4, respectively. Accordingly, the state of a fuse device may be shifted from the first state S1 to the second state S2 and the third state S3 by applying the same programming voltage for different durations of application, according to example embodiments.

FIG. 7 is a graph showing changes of electrical resistance in the fuse device of FIG. 1 with respect to the duration of applying the programming voltage. Referring to FIG. 7, electrical resistance of the fuse device increases in stepped increments as the duration of applying the programming voltage increases. In other words, the fuse device may have notably distinguished electrical resistances in each of the first through third states S1 through S3.

According to example embodiments, the state of a fuse device may be changed by applying different programming voltages which have different strengths to each other. More particularly, the state of the fuse device of FIG. 2 may be shifted to the state of FIG. 3 or the state of FIG. 4 according to the strength of the programming voltage applied between the cathode 100 and the anode 200 of the fuse device of FIG. 2. In other words, only the first upper metal layer M1 may be selectively blown by applying a first programming voltage between the cathode 100 and the anode 200 of FIG. 2 for a predetermined or given period of time, or both the first upper metal layer M1 and the first lower metal layer UL1 may be blown by applying a second programming voltage greater than the first programming voltage for a predetermined or given period of time.

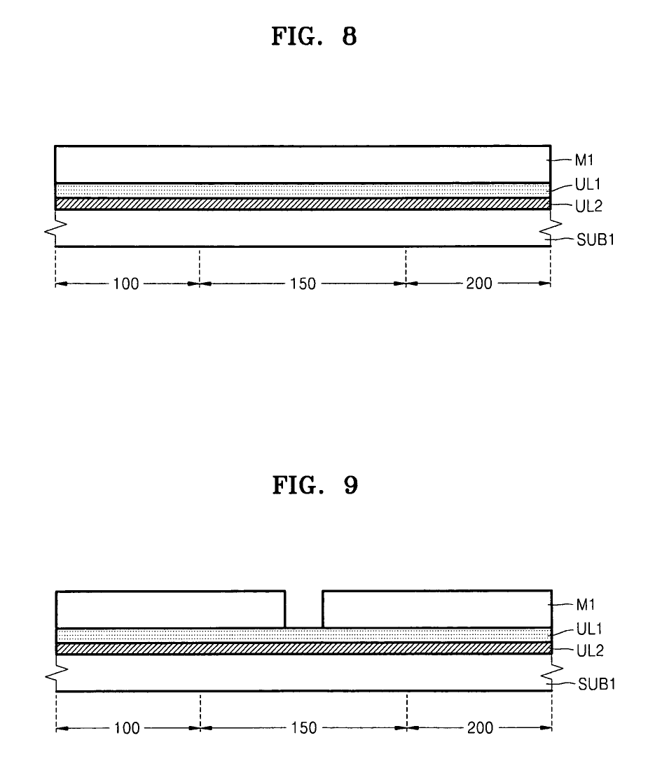

FIG. 8 is a sectional view of a fuse device according to example embodiments. The structure shown in FIG. 8 is identical to the structure shown in FIG. 2 except that the structure of FIG. 8 further includes a second lower metal layer UL2 between the substrate SUB1 and the first lower metal layer UL1. The plane structure of the fuse device of FIG. 8 may be similar to that of the fuse device of FIG. 1.

The electrical resistance of the second lower metal layer UL2 of FIG. 8 may be higher than that of the first lower metal layer UL1. Furthermore, the melting point of the second lower metal layer UL2 may be higher than that of the first lower metal layer UL2. For example, the second lower metal layer UL2 may include one of Ti, TiN, Ta, TaN, TiSi, TaSi, TiSiN, TaSiN, TiAl₃, and TiON. In other words, a material having lower electrical resistance may be used for the first lower metal layer UL1, and another material having higher electrical resistance may be used for the second lower metal layer UL2, e.g., Ti, TiN, Ta, TaN, TiSi, TaSi, TiSiN, TaSiN, TiAl₃, and TiON. However, example embodiments are not limited thereto, and thus materials other than the materials above may be used for the second lower metal layer UL2.

The fuse device of FIG. 8 may correspond to a first state in which the fuse device has a first electrical resistance R1′, and may be shifted to states shown in FIGS. 9 through 11 due to programming operations. Referring to FIG. 9, a predetermined or given region of the first upper metal layer M1 may be blown, whereas the first lower metal layer UL1 and the second lower metal layer UL2 are intact. The fuse device of FIG. 9 may correspond to a second state in which the fuse device has a second electrical resistance R2′.

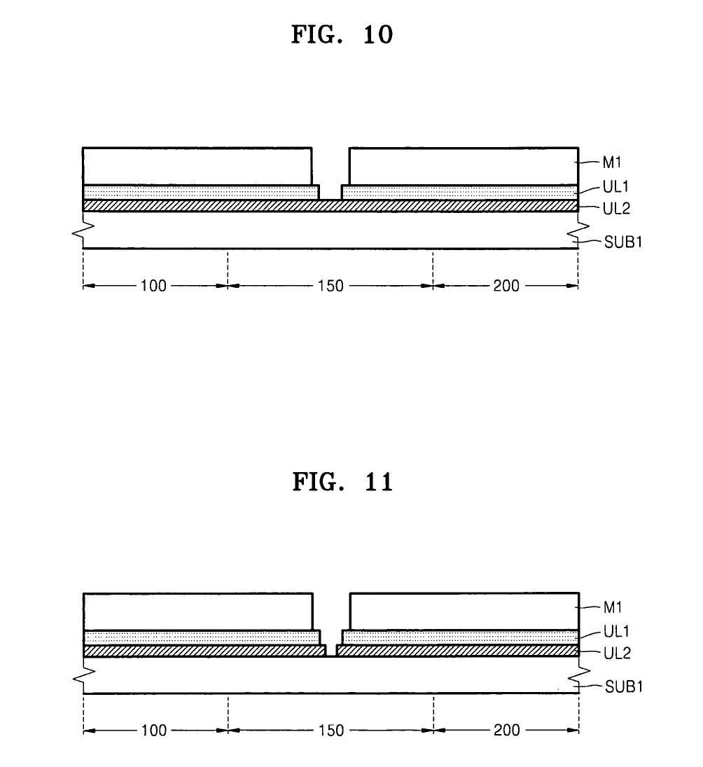

Referring to FIG. 10, predetermined or given regions of the first upper metal layer M1 and the first lower metal layer UL1 may be blown, whereas the second lower metal layer UL2 is intact. The fuse device of FIG. 10 may correspond to a third state in which the fuse device has a second electrical resistance R3′. Referring to FIG. 11, predetermined or given regions of the first upper metal layer M1, the first lower metal layer UL1, and the second lower metal layer UL2 may be blown. The fuse device of FIG. 11 may correspond to a fourth state in which the fuse device has a second electrical resistance R4′.

The first through fourth electrical resistances R1′ through R4′ may be electrical resistances between the cathode 100 and the anode 200, and the relationship among the first through fourth electrical resistances R1′ through R4′ may be R1′<R2′<R3′<R4′. Thus, the first through fourth states may correspond to data “00,” “01,” “10,” and “11,” respectively. A fuse device according to example embodiments may have four resistive states which are different from each other.

A method of programming the fuse device of FIG. 8 may be similar to the method of programming the fuse device of FIG. 2. In other words, the state of the fuse device of FIG. 8 may be shifted to the states shown in FIG. 9 through 11 by applying the same programming current for different durations of application. Furthermore, the state of the fuse device of FIG. 8 may also be shifted to the states shown in FIG. 9 through 11 by applying programming voltages with different strengths.

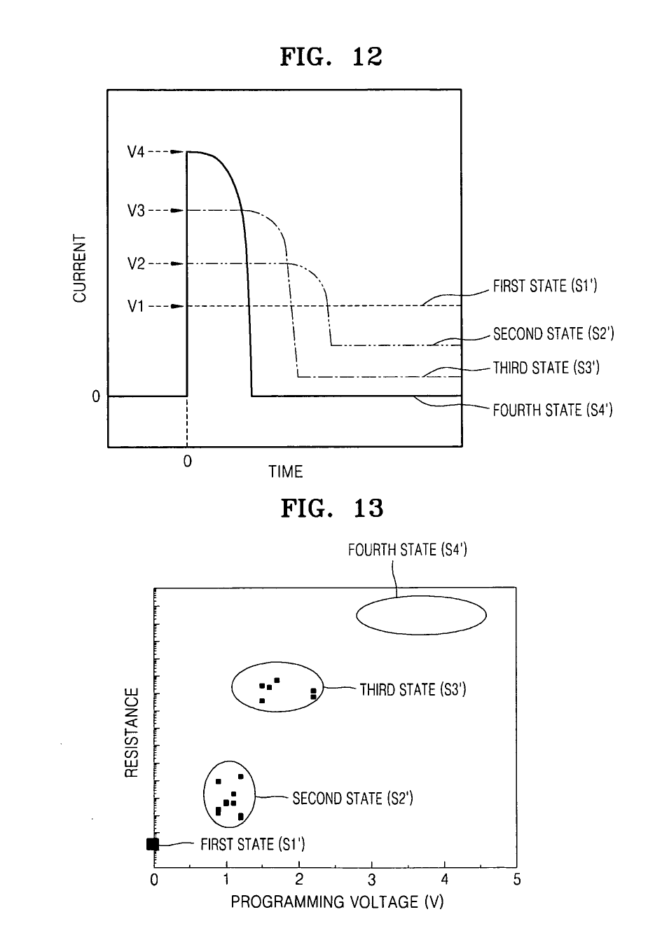

FIG. 12 is a graph showing changes of electric current in the fuse device of FIG. 8 with respect to the duration of applying programming voltages with different strengths. The results shown in FIG. 12 are regarding a fuse device having the structure of FIG. 8 using an Al layer, a Ti layer, and a TiN layer as the first upper metal layer M1, the first lower metal layer UL1, and the second lower metal layer UL2, respectively.

Referring to FIG. 12, when a first voltage V1, which is a voltage lower than a predetermined or given critical voltage, is applied to the fuse device, a first electric current may flow through the fuse device while the first upper metal layer M1, the first lower metal layer UL1, and the second lower metal layer UL2 are not blown. In example embodiments, the fuse device may maintain the state of FIG. 8, that is, a first state S1′. Because the first voltage V1 does not change the state of the fuse device, the first voltage V1 may not be a programming voltage, but a measuring voltage. Second through fourth voltages V2 through V4 may be programming voltages.

If the second voltage V2, which is a voltage higher than the first voltage V1, is applied to the fuse device instead of the first voltage V1, only the first upper metal layer M1 may be blown, and a second electric current, which is a current lower than the first electric current, may flow through the fuse device. In other words, the state of the fuse device may be shifted to the state of FIG. 9, that is, a second state S2′ due to the second voltage V2. If the third voltage V3, which is a voltage higher than the second voltage V2, is applied to the fuse device, the first upper metal layer M1 and the first lower metal layer UL1 may be blown, and a third electric current, which is a current lower than the second electric current, may flow through the fuse device. In other words, the state of the fuse device may be shifted to the state of FIG. 10, that is, a third state S3′ due to the second voltage V3.

If the fourth voltage V4, which is a voltage higher than the third voltage V3, is applied to the fuse device, the first upper metal layer M1, the first lower metal layer UL1, and the second lower metal layer UL2 may all be blown, and thus almost no electrical current may flow through the fuse device. In other words, the state of the fuse device may be shifted to the state of FIG. 11, that is, a fourth state S4′ due to the fourth voltage V4.

FIG. 13 is a graph showing changes of electrical resistance in the fuse device of FIG. 8 with respect to strength of programming voltages applied. Referring to FIG. 13, electrical resistance of the fuse device may increase in stepped increments as the strength of the programming voltage applied increases. In other words, the fuse device may have notably distinguished electrical resistances in each of the first through fourth states S1′ through S4′.

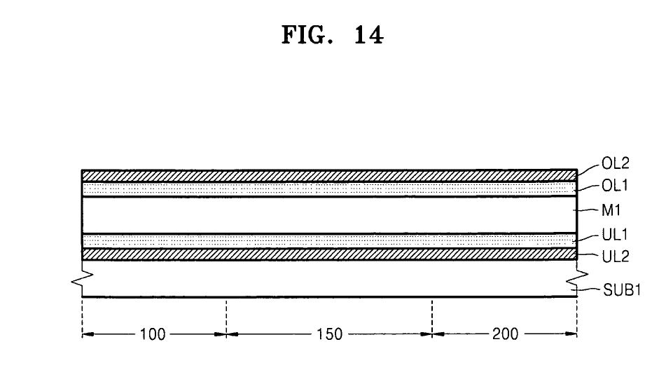

According to example embodiments, at least one metal layer may further be disposed on the first upper metal layer M1 of FIG. 2 or FIG. 8. The at least one metal layer may have a single-layer structure or a multi-layer structure, both of which include at least one of Ti, TiN, Ta, TaN, TiSi, TaSi, TiSiN, TiAl₃, and TiON. Furthermore, at least one different metal layer may further be disposed under the first upper metal layer M1. An example in which at least one metal layer is disposed on the first upper metal layer M1 of FIG. 8 is shown in FIG. 14.

Referring to FIG. 14, second and third upper metal layers OL1 and OL2 may be further disposed on the first upper metal layer M1. The second and third upper metal layer OL1 and OL2 may each include at least one of Ti, TiN, Ta, TaN, TiSi, TaSi, TiSiN, TaSiN, TiAl₃, and TiON, may be layers which are different from each other, and may have different electrical resistance and/or different melting points. The second upper metal layer OL1 may be formed of the same material as the first lower metal layer UL1, and the third upper metal layer OL2 may be formed of the same material as the second lower metal layer UL2. For example, the fuse link 150 may have a stacked structure in which a TiN layer, a Ti layer, an Al layer, a Ti layer, and a TiN layer are stacked. In example embodiments, if the thickness of the second upper metal layer OL1 and the thickness of the first lower metal layer UL1 are the same, the layers OL1 and UL1 may be blown simultaneously. Similarly, if the thickness of the third upper metal layer OL2 and the thickness of the second lower metal layer UL2 are same, the layers OL2 and UL2 may be blown simultaneously. However, example embodiments are not limited thereto, and materials for forming the second and third upper metal layers OL1 and OL2 and stacked structure of the fuse link 150 may vary.

In FIG. 2, positions of the first lower metal layer UL1 and the first upper metal layer M1 may be interchanged. In FIG. 8, positions of the first lower metal layer UL1, the second lower metal layer UL2, and the first upper metal layer M1 may be interchanged. In FIG. 14, positions of the first lower metal layer UL1, the second lower metal layer UL2, the first upper metal layer M1, the second upper metal layer OL1, and the third upper metal layer OL2 may be interchanged. Furthermore, the thicknesses of the layers UL1, UL2, M1, OL1, and OL2 may vary, and at least two of the layers UL1, UL2, M1, OL1, and OL2 may be formed of the same material. Furthermore, where the thicknesses of the first and second lower metal layers UL1 and UL2 are relatively small, the two layers UL1 and UL2 may act like a single layer, and may be blown almost simultaneously. Similarly, where the thicknesses of the second and third upper metal layers OL1 and OL2 are relatively small, the two layers OL1 and OL2 may act like a single layer, and may be blown almost simultaneously. Therefore, even if a fuse device includes three stacked metal layers as shown in FIG. 8, the fuse device may have three states which are different from each other similar to the states shown in FIG. 7.

The fuse devices according to example embodiments described above may be arranged in plural to form a second-dimensional array, and may be applied for various purposes to semiconductor memory devices, logic devices, microprocessors, field programmable gate arrays (FPGA), and very large scale integration (VLSI) circuits. As described above, a fuse device according to example embodiments may have three or four states which are different from each other. In other words, a multi-state fuse device, which has three or more different states, may be embodied according to example embodiments. Therefore, according to example embodiments, the size per bit of a fuse device may be significantly reduced as compared to a conventional fuse device, that is, a single bit fuse device having two states which are different from each other.

Furthermore, a fuse device having multi metal layers according to example embodiments may be fabricated by using materials for metal gates in a cell region or materials for metal wiring, and thus, may be more easily fabricated by using conventional semiconductor device fabricating operations and in synchronization with operations fabricating a cell region. For example, the material(s) of the first lower metal layer UL1 and/or the second lower metal layer UL2 below the first upper metal layer M1 may function as seed layers, adhesion layers, or diffusion barriers. The material(s) of the second upper metal layer OL1 and/or the third upper metal layer OL2 on the first upper metal layer M1 may function as anti-reflective coating (ARC) layers.

Furthermore, where a W layer is used as the first upper metal layer M1, a programming current required for blowing the first upper metal layer M1 may be relatively small (less than or equal to about 10 mA). Thus, the size of a programming transistor connected to the cathode 100 or the anode 200 may be reduced. Additionally, where a fuse device is programmed by using the same programming voltages with different durations of application, configuration of a driving element connected to a programming transistor may be further simplified.

While example embodiments have been particularly shown and described with reference to example embodiments thereof, it will be understood by those skilled in the art that various changes in form and details may be made therein without departing from the spirit and scope of the appended claims. Example embodiments should be considered in a descriptive sense only and not for purposes of limitation. For example, those skilled in the art should understand that structures and components of fuse devices shown in FIGS. 1, 2, 8, and 14 may be changed or be varied. For example, a fuse device having more than four states which are different from each other may be embodied by increasing the number of metal layers forming the fuse link 150. Furthermore, the sizes of the cathode 100 and the anode 200 may be different from each other, and shapes of the cathode 100, the anode 200, and the fuse link 150 may vary. Therefore, the scope of example embodiments is defined not by the detailed description of example embodiments, but by the appended claims, and all differences within the scope will be construed as being included in example embodiments.

What is claimed is:

1. An electrical fuse device comprising:
a cathode and an anode separated from each other; and
a fuse link connecting the cathode and the anode,
wherein the fuse link includes at least two stacked metal layers configured such that at least one of the stacked metal layers is blown from among the at least two stacked metal layers, the number of the stacked metal layers blown varying according to one of the strength and the duration of application of a voltage to the fuse link.

2. The electrical fuse device of claim 1, wherein the fuse link comprises:
a first lower metal layer; and
a first upper metal layer on the first lower metal layer.

3. The electrical fuse device of claim 2, wherein the first lower metal layer and the first upper metal layer have different electrical resistances from each other.

4. The electrical fuse device of claim 2, wherein the first lower metal layer and the first upper metal layer have different melting points from each other.

5. The electrical fuse device of claim 2, wherein one of the first lower metal layer and the first upper metal layer comprises one of W, Al, Cu, Ag, Au, and Pt.

6. The electrical fuse device of claim 5, wherein the other one of the first lower metal layer and the first upper metal layer comprises one of Ti, TiN, Ta, TaN, TiSi, TaSi, TiSiN, TaSiN, TiAl₃, and TiON.

7. The electrical fuse device of claim 2, wherein one of the first lower metal layer and the first upper metal layer comprises one of Ti, TiN, Ta, TaN, TiSi, TaSi, TiSiN, TaSiN, TiAl₃, and TiON.

8. The electrical fuse device of claim 2, wherein the fuse link further comprises: a second lower metal layer below the first lower metal layer.

9. The electrical fuse device of claim 8, wherein at least two of the first lower metal layer, the second lower metal layer, and the first upper metal layer have different electrical resistances from each other.

10. The electrical fuse device of claim 8, wherein at least two of the first lower metal layer, the second lower metal layer, and the first upper metal layer have different melting points from each other.

11. The electrical fuse device of claim 8, wherein one of the first lower metal layer, the second lower metal layer, and the first upper metal layer comprises one of W, Al, Cu, Ag, Au, and Pt.

12. The electrical fuse device of claim 11, wherein another one of the first lower metal layer, the second lower metal layer, and the first upper metal layer comprises one of Ti, TiN, Ta, TaN, TiSi, TaSi, TiSiN, TaSiN, TiAl₃, and TiON.

13. The electrical fuse device of claim 12, wherein the other one of the first lower metal layer, the second lower metal layer, and the first upper metal layer comprises one of Ti, TiN, Ta, TaN, TiSi, TaSi, TiSiN, TaSiN, TiAl₃, and TiON.

14. The electrical fuse device of claim 2, wherein the fuse link further comprises:
at least one metal layer on the first upper metal layer.

15. The electrical fuse device of claim 14, wherein the at least one metal layer is an ARC (anti-reflective coating) layer.

16. The electrical fuse device of claim 14, wherein the at least one metal layer has either a single layer structure or a multi layer structure, both of which comprises at least one of Ti, TiN, Ta, TaN, TiSi, TaSi, TiSiN, TaSiN, TiAl₃, and TiON.

17. A method of operating an electrical fuse device comprising:
providing a fuse link between a cathode and an anode, the fuse link including at least two stacked metal layers; and
blowing at least one of the at least two stacked metal layers by applying a voltage between the cathode and the anode.

18. The method of claim 17, wherein the strength of a voltage applied between the cathode and the anode is constant, and the number of metal layers blown from among the at least two stacked metal layers is determined by the duration of application of the voltage.

19. The method of claim 17, wherein the number of metal layers blown from among the at least two stacked metal layers is determined by the strength of a voltage applied between the cathode and the anode.

20. The method of claim 17, wherein at least two of the at least two metal layers have different electrical resistances from each other and at least two metal layers have different melting points from each other.
